(19) United States
(12) Patent Application Publication
(10) Pub. No.: US 2014/0160769 A1
(43) Pub. Date: Jun. 12, 2014

(54) LIGHT REFLECTOR FOR IMITATION FIREPLACE

(71) Applicant: Zhijian JIANG, Quanzhou City (CN)

(72) Inventor: Zhijian JIANG, Quanzhou City (CN)

(73) Assignee: QUANZHOU SHUNTONG CRAFTS CO., LTD., Quanzhou City (CN)

(21) Appl. No.: 13/711,606

(22) Filed: Dec. 11, 2012

(51) Int. Cl. F21V 7/00

(52) U.S. Cl. CPC F21V 7/0025
USPC 362/346

(57) ABSTRACT

A light reflector for an imitation fireplace includes a shaft and a light-reflecting strip. The light-reflecting strip has two sets of light-reflecting pieces at two sides thereof. The light-reflecting strip is spirally wounded on the shaft. Two ends of the light-reflecting strip are tightly fixed to the shaft. Each set of the light-reflecting pieces includes large light-reflecting pieces and small light-reflecting pieces. The large light-reflecting pieces and the small light-reflecting pieces are interlaced each other. The light-reflecting strip and the light-reflecting pieces are made of a plate which is formed in one stamping operation. The light-reflecting strip of the present invention can be replaced conveniently and the cost is low. It is convenient to manufacture the present invention. The blaze effect of the present invention is changeful and almost real.

### BACKGROUND OF THE INVENTION

1. Field of the Invention

The present invention relates to an imitation fireplace technique, and more particularly to a light reflector for an imitation fireplace.

2. Description of the Prior Art

An imitation fireplace is widely used in a public house, home or public place for decoration. The imitation fireplace comprises a housing and a blaze-like device mounted in the housing. The blaze-like device comprises a light source, a light reflector to imitate blaze, an electric machine and an image screen. The electric machine drives the light reflector to turn. The light from the light source is reflected to the image screen through the turning of the light reflector to imitate blaze.

As shown in FIG. 1, the light reflector of the imitation fireplace comprises a shaft 1 and two light-reflecting strips 02. The two light-reflecting strips 02 each have light-reflecting pieces 03 disposed along its lengthwise direction. The shaft 1 has a groove 01 along its lengthwise direction. The ends of the two overlapped light-reflecting strips 02 are respectively inserted in the groove 01, and then the shaft 1 is twisted to a spiral form. The two light-reflecting strips 02 are fixed in the groove 01 of the shaft 1. Finally, the light-reflecting pieces 03 on the two light-reflecting strips 02 are separately bent to become the light reflector. The shaft 1 of this light reflector must have the groove 01, so it is more troublesome for production and it is difficult to bend the shaft 1. After the shaft 1 is twisted, the light-reflecting strips 02 cannot be returned so it is unable to replace the light-reflecting pieces 03.

Accordingly, the inventor of the present invention has devoted himself based on his many years of practical experiences to solve this problem.

### SUMMARY OF THE INVENTION

The primary object of the present invention is to provide a light reflector for an imitation fireplace, which comprises a light-reflecting strip that can be replaced conveniently.

A further object of the present invention is to provide a light reflector for an imitation fireplace, which comprises large and small light-reflecting pieces that are interlaced each other.

In order to achieve the aforesaid objects, the light reflector for an imitation fireplace comprises a shaft and a light-reflecting strip. The light-reflecting strip has two sets of light-reflecting pieces at two sides thereof. The light-reflecting strip is spirally wounded on the shaft. Two ends of the light-reflecting strip are tightly fixed to the shaft. Thus, the shaft doesn't need a groove. A simple straight rod can be used. One end of the light-reflecting strip is fixed to the shaft, and then the light-reflecting strip is spirally wound on the shaft. Finally, the other end of the light-reflecting strip is fixed to the shaft to complete the light reflector.

Preferably, each set of the light-reflecting pieces comprises large light-reflecting pieces and small light-reflecting pieces, and the large light-reflecting pieces and the small light-reflecting pieces are interlaced each other. Thus, the blaze is changeful and almost real.

Preferably, the light-reflecting strip and the light-reflecting pieces are made of a plate which is formed in one stamping operation, after stamping, the plate is formed with an outer contour line, inner cut lines and inner closed line frames, the inner cut lines are connected with the outer contour line to form the light-reflecting strip at a middle portion of the plate and the two sets of light-reflecting pieces at the two sides of the light-reflecting strip, the interlaced large and small light-reflecting pieces of each set of light-reflecting pieces are formed by the inner cutting lines, an inner end of each inner cut line is connected with a corresponding inner closed line frame, and a cut-out piece is defined by each inner closed line frame between the adjacent large and small light-reflecting pieces and the light-reflecting strip. This stamping structure fully utilizes the plate to lower the cost and can be processed with ease.

Preferably, the two ends of the light-reflecting strip are tightly fixed to the shaft with adhesive or typing tapes. When in use, the light-reflecting strip won't fall off and can be replaced easily.

Compared to the prior art, the present invention, the light-reflecting strip is detachable relative to the shaft and can be conveniently replaced as desired. The light reflector can be produced conveniently. The large and small light-reflecting pieces are interlaced and disposed on the shaft to provide a more real blaze effect.

### BRIEF DESCRIPTION OF THE DRAWINGS

FIG. 1 is a schematic view of the prior art;

FIG. 2 is a schematic view showing the light-reflecting strip of the present invention;

FIG. 3 is another schematic view showing the light-reflecting strip of the present invention; and

FIG. 4 is a perspective view showing the light reflector of the present invention.

### DETAILED DESCRIPTION OF THE PREFERRED EMBODIMENTS

Embodiments of the present invention will now be described, by way of example only, with reference to the accompanying drawings.

FIG. 2 and FIG. 3 show a preferred embodiment of the present invention. The light reflector for an imitation fireplace of the present invention comprises a shaft 1 and a light-reflecting strip 2. The light-reflecting strip 2 has two sets of light-reflecting pieces 3 at two sides thereof. The light-reflecting strip 2 is spirally wounded on the shaft 1. Two ends of the light-reflecting strip 2 are tightly fixed to the shaft 1.

Each set of the light-reflecting pieces 3 comprises large light-reflecting pieces 31 and small light-reflecting pieces 32. The large light-reflecting pieces 31 and the small light-reflecting pieces 32 are interlaced each other.

The light-reflecting strip 2 and the light-reflecting pieces 3 are made of a plate which is formed in one stamping operation. After stamping, the plate is formed with an outer contour line 34, inner cut lines 35 and inner closed line frames 36. The inner cut lines 35 are connected with the outer contour line 34 to form the light-reflecting strip 2 at a middle portion of the plate and the two sets of light-reflecting pieces 3 at the two sides of the light-reflecting strip 2. The interlaced large and small light-reflecting pieces 31, 32 of each set of light-reflecting pieces 3 are formed by the inner cutting lines 35. The inner end of each inner cut line 35 is connected with a corresponding inner closed line frame 36. A cut-out piece 33 is defined by each inner closed line frame 36 between the adjacent large and small light-reflecting pieces 31, 32 and the light-reflecting strip 2. After the cut-out piece 33 is removed from the plate, the adjacent large and small light-reflecting pieces 31, 32 each have a bottom to be bent so that the modeling of the light-reflecting pieces 3 is almost real. This stamping structure fully utilizes the plate to lower the cost and can be processed with ease.

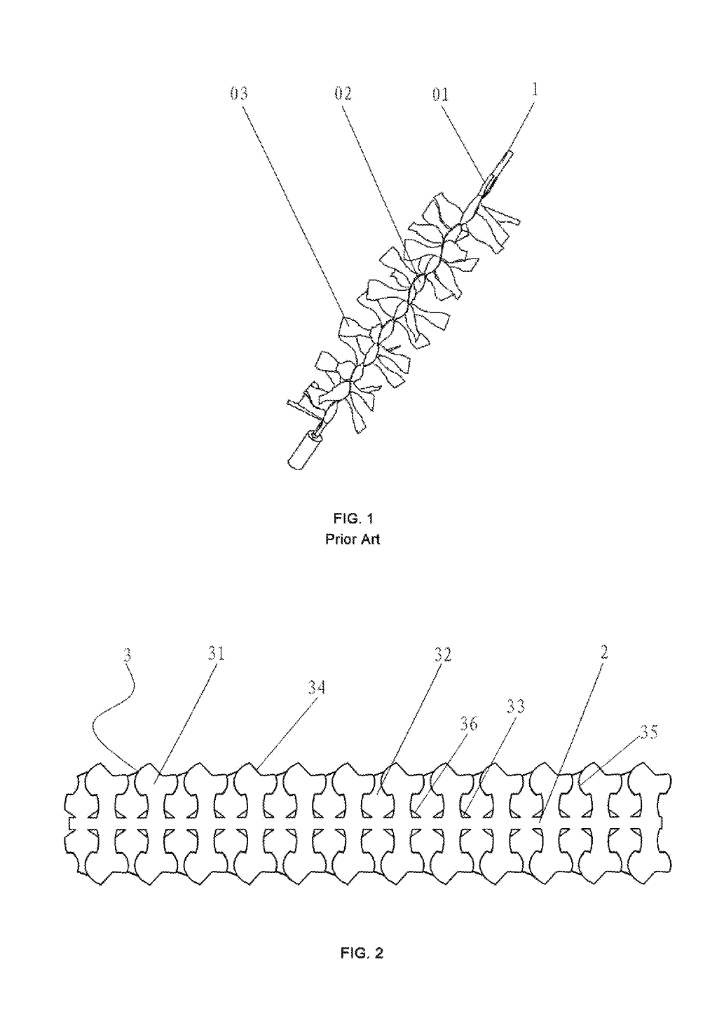

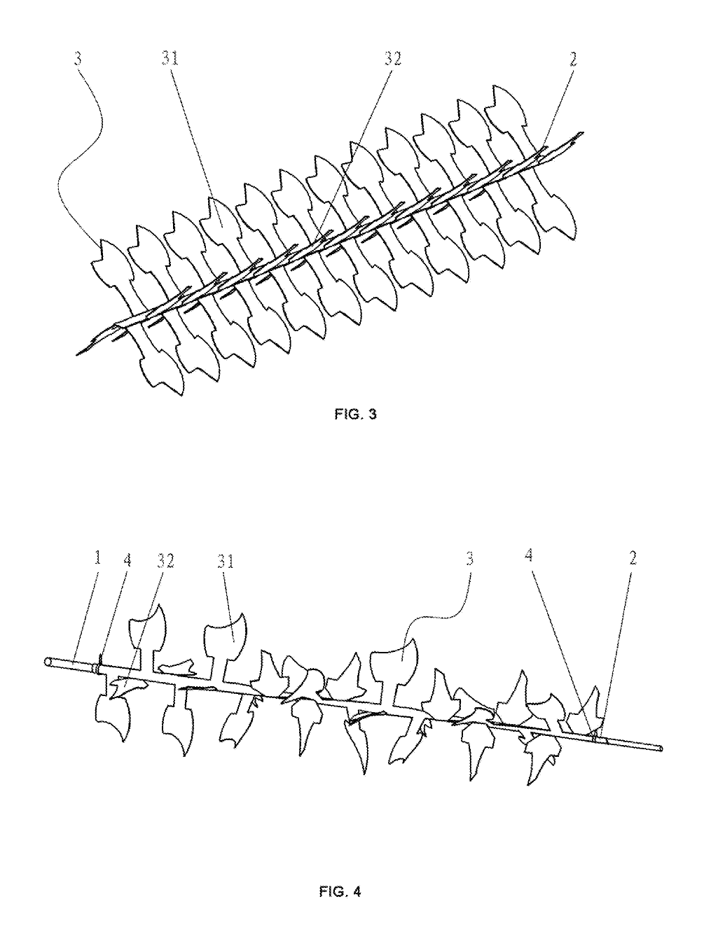

As shown in FIG. 4, each light-reflecting piece 3 is bent at a different angle relative to the light-reflecting strip 2. After that, one end of the light-reflecting strip 2 is tightly fixed to the shaft 1 with a typing tape 4, and then the light-reflecting strip 2 is spirally wound on the shaft 1. Finally, the other end of the light-reflecting strip 2 is tightly fixed to the shaft 1 with the typing tape 4 to constitute the light reflector.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A light reflector for an imitation fireplace, comprising a shaft and a light-reflecting strip, the light-reflecting strip having two sets of light-reflecting pieces at two sides thereof, the light-reflecting strip being spirally wounded on the shaft, two ends of the light-reflecting strip being tightly fixed to the shaft.

2. The light reflector for an imitation fireplace as claimed in claim 1, wherein each set of the light-reflecting pieces comprises large light-reflecting pieces and small light-reflecting pieces, and the large light-reflecting pieces and the small light-reflecting pieces are interlaced each other.

3. The light reflector for an imitation fireplace as claimed in claim 1, wherein the light-reflecting strip and the light-reflecting pieces are made of a plate which is formed in one stamping operation, after stamping, the plate is formed with an outer contour line, inner cut lines and inner closed line frames, the inner cut lines are connected with the outer contour line to form the light-reflecting strip at a middle portion of the plate and the two sets of light-reflecting pieces at the two sides of the light-reflecting strip, the interlaced large and small light-reflecting pieces of each set of light-reflecting pieces are formed by the inner cutting lines, an inner end of each inner cut line is connected with a corresponding inner closed line frame, and a cut-out piece is defined by each inner closed line frame between the adjacent large and small light-reflecting pieces and the light-reflecting strip.

4. The light reflector for an imitation fireplace as claimed in claim 1, wherein the two ends of the light-reflecting strip are tightly fixed to the shaft with one of adhesive or typing tapes.
